(19) United States
(12) Patent Application Publication
(10) Pub. No.: US 2004/0096101 A1
(43) Pub. Date: May 20, 2004

(54) Calculation method of nuclear reactor core

(76) Inventors: Masaaki Mori, Suita City (JP); Masayuki Hijiya, Sakai City (JP); Naoki Sugimura, Hirakata City (JP)

Correspondence Address: FLYNN THIEL BOUTELL & TANIS, P.C., 2026 RAMBLING ROAD, KALAMAZOO, MI, 49008-1699, US

(21) Appl. No.: 10/219,705

(22) Filed: Aug. 15, 2002

(30) Foreign Application Priority Data
Aug. 29, 2001 (JP) 2001-259604

(51) Int. Cl. G06K 9/00

(52) U.S. Cl. 382/162

(57) ABSTRACT

A calculation method of nuclear reactor core on neutronic characteristics and thermal hydraulic characteristics is provided, which is capable of getting an equivalent calculation precision to a heterogeneous core calculation by a coarse mesh core calculation thereby achieving curtailment and reduction of calculation time and memory capacity. It comprises conducting both a coarse mesh core calculation based on fuel assembly cross section tables including homogeneous fuel assembly cross sections and discontinuity factors at fuel assemblies boundaries and a heterogeneous core calculation on the premise of the same core conditions as in the aforesaid calculation; comparing two calculation results so obtained with each other to derive correction factors to the homogeneous cross sections and the discontinuity factors; and further conducting another coarse mesh core calculation using these correction factors to get final calculation results equivalent in precision to ones obtainable from a heterogeneous core calculation method at high speed.

### BACKGROUND OF THE INVENTION

1. Field of the Invention

This invention relates to an improvement in a calculation method for conducting a calculation of a nuclear reactor core at high speed and with high precision.

By the term “calculation of a nuclear reactor core” herein used throughout this invention is meant a computer simulation by mathematical calculation of various physical phenomena occurring in an operation process of a nuclear reactor, such as behaviors of neutrons (neutronic characteristics), thermal hydraulic behaviors, etc.

2. Description of the Related Art

The calculation method of a nuclear reactor core (hereinafter simply referred to as “core calculation”) currently prevailing, for example in core designing for purposes of an optimal fuel arrangement, is grouped mainly into a heterogeneous core calculation, which treats the core in terms of units of fuel rod cells each composed of fuel pellets, a cladding tube, coolant, etc. and a coarse mesh core calculation, which treats fuel assemblies by homogenization thereof.

The heterogeneous core calculation further includes a method of treating areas of fuel rod cells each made up of fuel pellets, a cladding tube, coolant, etc. under homogenization thereof and a method of treating areas of fuel pellets, cladding tubes, coolant, etc. as they are, without homogenization of them.

It is a current general practice to carry out, as a heterogeneous core calculation, a radial two-dimensional calculation, wherein only a radial core dependency is calculated, with an axial core dependency being treated on the average. Where this heterogeneous core calculation approach is adopted, however, there arises a necessity of treating the axial core dependency in an approximation method by an axial one-dimensional core calculation, which treats the radial core dependency on the average.

In the coarse mesh core calculation implemented at present, first each fuel assembly is divided into 1 or 4 meshes in a radial direction and into several meshes in the axial direction, and secondly a three-dimensional core calculation is conducted by homogenizing each of divided meshes. With the coarse mesh core calculation, the homogenization of fuel assemblies causes an error of neutron currents at boundaries of fuel assemblies and in order to alleviate the error, neutron flux discontinuity factors at fuel assemblies boundaries are generally introduced.

With the recent progress of computers, a three-dimensional heterogeneous core calculation, which performs a mesh division also in core-axis directions, is being put into practical use, but its application is limited, at the present time, to zero power condition in an undepleted initial loading core, which condition is not affected by fuel temperature distributions, water density distributions, etc.

To simulate the core in its operating state, it is necessary to iterate alternately neutronics calculation and thermal hydraulic calculation, while taking influences of the fuel temperature distributions, water density distributions, etc. upon the fuel cross sections (feedback effect) into consideration. This consumes an extremely long calculation time and requires a large memory capacity of the computer.

Because of the above-mentioned problems, the application of a three-dimensional heterogeneous core calculation to an online core calculation at an on-site computer of a nuclear power plant, which requires a high speed calculation, or to a time-dependent kinetic calculation of a core is not practical and feasible.

According to the theory of a homogenization approach of fuel assemblies making use of the neutron flux discontinuity factors, which is a typical approach in the coarse mesh calculation, by the application of homogeneous cross sections of fuel assemblies and discontinuity factors at fuel assemblies boundaries calculated by use of heterogeneous core calculation results to the coarse mesh core calculation, it is possible to obtain equivalent calculation results to the heterogeneous core calculation results by that coarse mesh core calculation. However, if the heterogeneous core calculation is conducted every time the coarse mesh core calculation is conducted, the coarse mesh core calculation will be meaningless. Consequently, when the homogeneous cross sections of fuel assemblies and discontinuity factors at fuel assemblies boundaries will be got, it is general to take the approximation approach that a heterogeneous calculation is performed on a hypothetical fuel assembly system such that fuel assemblies being noted are arranged infinitely, thereby to derive the homogeneous cross sections of fuel assemblies and the discontinuity factors at fuel assemblies boundaries, which are in turn applied to the coarse mesh core calculation.

According to this approach, it is possible to conduct the heterogeneous calculation on a single fuel assembly system by setting perfect reflexive conditions to neutron flux on a symmetry axis, making effective use of a symmetry nature of the infinite array.

Otherwise to diminish the degree of approximation in the aforementioned approach there is a further approach to derive the homogeneous fuel assembly cross sections and the discontinuity factors at fuel assemblies boundaries, by a heterogeneous calculation on a fuel assemblies system on the assumption that small-scale systems, each of which consists of only a fuel assembly being noted and adjacent fuel assemblies thereto, are arranged infinitely.

In this approach, by setting perfect reflexive conditions by effective use of the symmetry of infinite array it is possible to conduct the heterogeneous calculation of adjacent four-fuel assembly system. Here, however, it is necessary to conduct the calculation of adjacent fuel assemblies to every combination of adjacent fuel assemblies existing in the core, which renders the calculation procedure troublesome.

As a method for diminishing further the approximation degree and avoiding the intricacy of the calculation of adjacent fuel assemblies, it is conceivable to perform a two-dimensional heterogeneous core calculation based on the actual core system thereby to derive the homogeneous fuel assembly cross sections and discontinuity factors at fuel assemblies boundaries. In this method, however, in order to treat accurately effects of burn-up distributions, fuel temperature distributions, water density distributions, etc. in the core axis directions, there arises a necessity of dividing axially the core into a multiplicity of planes to conduct a two-dimensional heterogeneous core calculation in every divided plane. Besides, also in the two-dimensional heterogeneous core calculation in every divided plane, it is necessary to conduct iteration of neutronics calculation and thermal hydraulic calculation alternately in order to consider accurately the influences of the fuel temperature distributions and water density distributions upon the cross sections (feedback effect), which gives rise to problems of requiring a long calculation time and a large computer memory capacity.

### SUMMARY OF THE INVENTION

In order to cope with the problems in the present state of the art described above, the invention has been made by finding out a particular combination of a coarse mesh core calculation code with a heterogeneous core calculation code, and is aimed at obtaining ultimately a calculation precision equivalent to a heterogeneous core calculation by a coarse mesh core calculation, thus attaining a significant shortening in calculation time and a significant reduction in memory capacity.

This invention is concerned with a method for calculating a nuclear reactor core on neutronic characteristics and thermal hydraulic characteristics according to a coarse mesh core calculation code by taking advantage of effects of a heterogeneous core calculation code as mentioned above. That is, the method of the invention generically comprises the steps of: performing a coarse mesh core calculation by treating fuel assemblies based on fuel assembly cross section tables including homogeneous fuel assembly cross sections, discontinuity factors at fuel assemblies boundaries, etc. under homogenization thereof; performing a heterogeneous core calculation in a system based on the premise of the same core conditions as in the coarse mesh core calculation; comparing both calculation results thus obtained with each other thereby deriving correction factors to the homogeneous cross sections, discontinuity factors, etc.; and performing further another coarse mesh core calculation by use of the aforesaid correction factors, whereby to get final calculation results equivalent in precision to calculation results obtainable from a heterogeneous core calculation method at high speed.

According to more specific aspects (claims 4, 7) of the generic invention mentioned above, the aforesaid first and second coarse mesh core calculations and the aforesaid heterogeneous core calculation are a two-dimensional and a three-dimensional coarse mesh core calculations and a two-dimensional heterogeneous core calculation, respectively; the aforesaid correction factors derived are parameters at least including homogeneous cross sections of fuel assemblies and discontinuity factors at fuel assemblies boundaries, or parameters further including power distributions within fuel assemblies and reaction rates of in-core neutron detectors in addition to the former two; and the correction factors derived are used for the three-dimensional coarse mesh core calculation in a similar or analogous system to the system in the two-dimensional heterogeneous core calculation thereby getting final calculation results equivalent in precision to ones obtainable from a three-dimensional heterogeneous core calculation method at high speed.

According to further specific aspects (claims 10, 13) of the generic invention, the aforesaid first and second coarse mesh core calculations and the aforesaid heterogeneous core calculation are a first three-dimensional and a second three-dimensional coarse mesh core calculations and a three-dimensional heterogeneous core calculation, respectively; the aforesaid correction factors derived are correction factors to parameters including homogeneous fuel assembly cross sections and discontinuity factors at fuel assemblies boundaries or correction factors to parameters including power distributions in fuel assemblies and reaction rates of in-core neutron detectors, in addition to the homogeneous cross sections and the discontinuity factors; and these correction factors are used for the second three-dimensional coarse mesh core calculation in a similar or analogous system to the system in the three-dimensional heterogeneous core calculation, whereby to get final calculation results equivalent in precision to calculation results obtainable from a three-dimensional heterogeneous core calculation method at high speed.

Here, the final calculation results obtained are equivalent or comparable in calculation precision to calculation results obtainable from such a three-dimensional heterogeneous core calculation method when performed on the system in which the correction factors were derived.

In performing a calculation of a nuclear reactor core, a heterogeneous core calculation treating the core by fuel rod cell units each composed of fuel pellets, a cladding tube, and coolant and a coarse mesh core calculation treating fuel assemblies by homogenization thereof are conducted, the calculation results are compared to each other to derive correction factors to homogeneous fuel assembly cross sections, discontinuity factors at fuel assemblies boundaries, power distribution within fuel assemblies, and reaction rates of in-core neutron detectors are got.

At that time, by using boron concentrations, fuel temperature distributions, etc. derived in the first coarse mesh core calculation for the subsequent heterogeneous core calculation, it is possible to avoid the alternate iteration of neutronics calculation and thermal hydraulic calculation in the heterogeneous core calculation. Accordingly, a significant curtailment in calculation time and a significant reduction in memory capacity are feasible.

Then a second coarse mesh core calculation is conducted in a similar or analogous system (core conditions) to the system, in which the heterogeneous core calculation was conducted, by use of the correction factors derived.

As a result, it is possible to obtain ultimately an equivalent calculation precision to that of a (three-dimensional) heterogeneous core calculation method by reflecting the correction factors, by which the heterogeneous core calculation results are taken into account, to the second coarse mesh core calculation.

### BRIEF DESCRIPTION OF THE DRAWINGS

Several preferred embodiments of the invention will be hereinafter described in more detail with reference to the accompanying drawings, in which:

FIG. 1A and FIG. 1B jointly constitute a flow chart of one example of a core calculation procedure according to this invention, wherein a coarse mesh core calculation code and a two-dimensional heterogeneous core calculation are combined;

FIG. 2A and FIG. 2B jointly constitute a flow chart of another example of a core calculation procedure according to this invention, wherein a coarse mesh core calculation code and a three-dimensional heterogeneous core calculation are combined.

### DESCRIPTION OF THE PREFERRED EMBODIMENTS

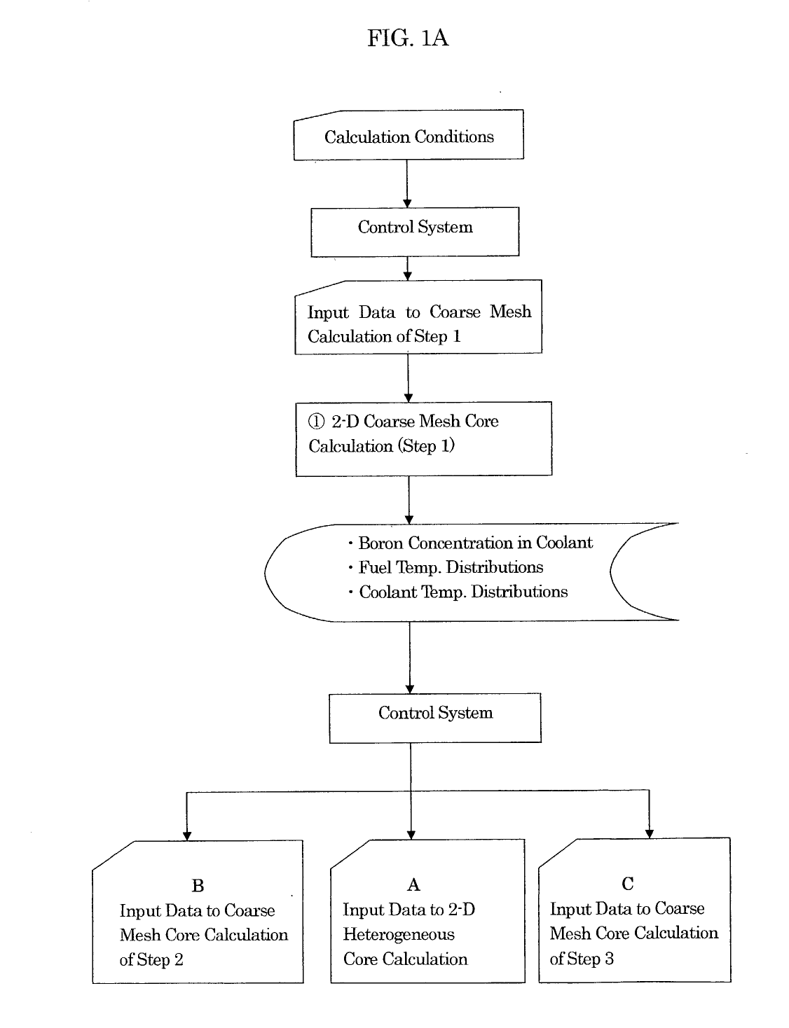

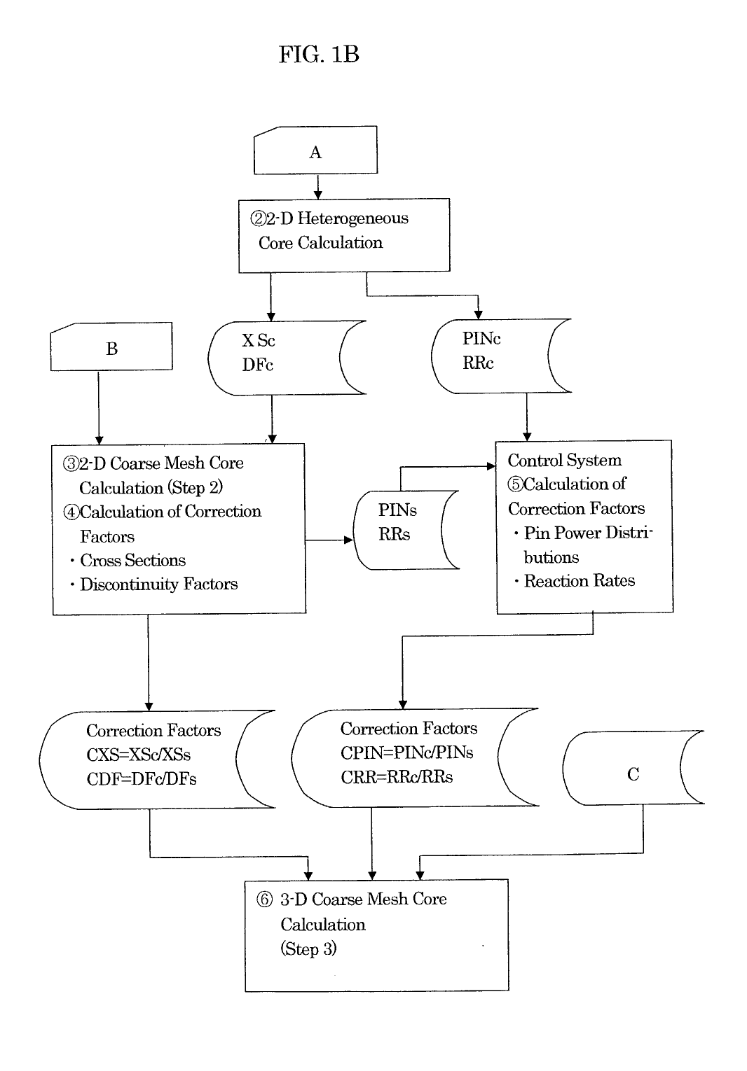

As one example of applying the core calculation method of this invention to a pressurized water reactor core, a hybrid core calculation system (control system) will now be described with reference to FIGS. 1A and 1B, wherein a two-dimensional heterogeneous core calculation and a coarse mesh core calculation code are combined. More specific calculation procedure will now be described hereinbelow.

\mathring{1} Two-Dimensional Coarse Mesh Core Calculation (Step 1)

According to a coarse mesh core calculation code, a two-dimensional core burn-up calculation (or control rod insertion or pulling out calculation) at Step 1 is carried out, and calculation results on core cycle burn-up degrees, boron concentrations at every burning step, pin temperature distributions, and coolant temperature distributions are output into an intermediate file.

Considering the application of the method to a pressurized water reactor having blanket fuels or enrichment distributions in the axial direction or to a boiling water reactor whose change in axial water density distributions is large owing to the generation of voids, it is also conceivable to change the two-dimensional coarse mesh core calculation at Step 1 to a three-dimensional core calculation and to conduct correction by performing a two-dimensional heterogeneous core calculation in every axially divided plane.

\mathring{2} Two-Dimensional Heterogeneous Core Calculation

On the basis of two-dimensional core calculation results at Step 1 [boron concentrations, pin temperature distributions and coolant (moderator) temperature distributions, etc. at every burn-up step], input data into a two-dimensional heterogeneous core calculation code are prepared and the core calculation is conducted.

From the two-dimensional heterogeneous core calculation code, as shown in FIG. 1B, homogeneous fuel assembly cross sections (XSc), discontinuity factors at fuel assemblies boundaries (DFc), pin power distributions (PIN) and reaction rates of in-core neutron detectors (RRc) are output as a file.

\mathring{3} Two-Dimensional Coarse Mesh Core Calculation (Step 2)

Under the same calculation conditions as in the two-dimensional heterogeneous core calculation above, a two-dimensional core calculation at Step 2 is executed according to the coarse mesh core calculation code.

In the calculation at Step 2, homogeneous fuel assembly cross sections (XSs) and discontinuity factors at fuel assemblies boundaries (DFs) in the coarse mesh core calculation code are replaced with two-dimensional heterogeneous core calculation results (XSc, DFc).

\mathring{4} Deriving of Correction Factors to Cross Sections and Discontinuity Factors

In replacing the homogeneous fuel assembly cross sections (XSs) and discontinuity factors at fuel assemblies boundaries (DFs) with the two-dimensional heterogeneous core calculation results (XSc, DFc) at the 2-dimensional coarse mesh core calculation (Step 2), the ratios of both are calculated by the formulae below. These ratios are correction factors to homogeneous fuel assembly cross sections and discontinuity factors at fuel assemblies boundaries (CXS, CDF).

CXS=XSc/XSs, CDF=DFc/DFs

\mathring{5} Calculating of Correction Factors to Pin Power Distributions and Reaction Rates of In-Core Neutron Detectors

From the ratios of pin power distributions in fuel assemblies (PINc) as 2-dimensional heterogeneous core calculation results to pin power distributions in fuel assemblies (PINs) as 2-dimensional coarse mesh core calculation results at Step 2, the correction factor to pin power distributions (CPIN) is got by the equation below. Similarly, the correction factor to reaction rates of in-core neutron detectors (CRR) is got from the ratios of reaction rates of in-core neutron detectors as the 2-dimensional heterogeneous core calculation results (RRc) to reaction rates of in-core neutron detectors as the 2-dimensional coarse mesh core calculation results at Step 2 (RRs) by the equation below.

CPIN=PINc/PINs, CRR RRc/Rs

\mathring{6} Three-Dimensional Coarse Mesh Core Calculation (Step 3)

After correcting by the correction factors obtained above, the resulting homogeneous fuel assembly cross sections (XS) and discontinuity factors at fuel assemblies boundaries (DF) are used to perform a 3-dimensional coarse mesh core calculation at Step 3.

The pin power distributions in fuel assemblies (PIN) and reaction rates of in-core neutron detectors (RR) obtained from \mathring{5} above are also corrected by use of the correction factors.

Thus,

XS (after correction)=XS (before correction)×Correction Factor

DF (after correction)=DF (before correction)×Correction Factor

PIN (after correction)=PIN (before correction)×Correction Factor

RR (after correction)=RR (before correction)×Correction Factor

By using the correction factors obtained from the 2-dimensional heterogeneous core calculation and 2-dimensional coarse mesh core calculation in the foregoing procedure, it is possible to obtain equivalent calculation precision to that of a 3-dimensional heterogeneous core calculation method from the 3-dimensional coarse mesh core calculation procedure above, without performing the 3-dimensional heterogeneous core calculation method requiring a tremendous calculation time and memory capacity.

This advantage is effective particularly in performing a kinetic calculation necessitating many calculation steps.

Furthermore, by performing the 2-dimensional heterogeneous core calculation by use of in-core temperature distributions, etc. calculated according to the 2-dimensional coarse mesh core calculation (Step 1), it is possible to avoid the alternate iteration of neutronics calculation and thermal hydraulic calculation, and also from this aspect, curtailment in calculation time is attainable.

In the example above, \mathring{1}: the 2-dimensional calculation (Step 1), \mathring{2}: the 2-dimensional heterogeneous core calculation and \mathring{3}: the 2-dimensional coarse mesh core calculation (Step 2) are all 2-dimensional, but these may also be carried out in 3-dimensional core calculation.

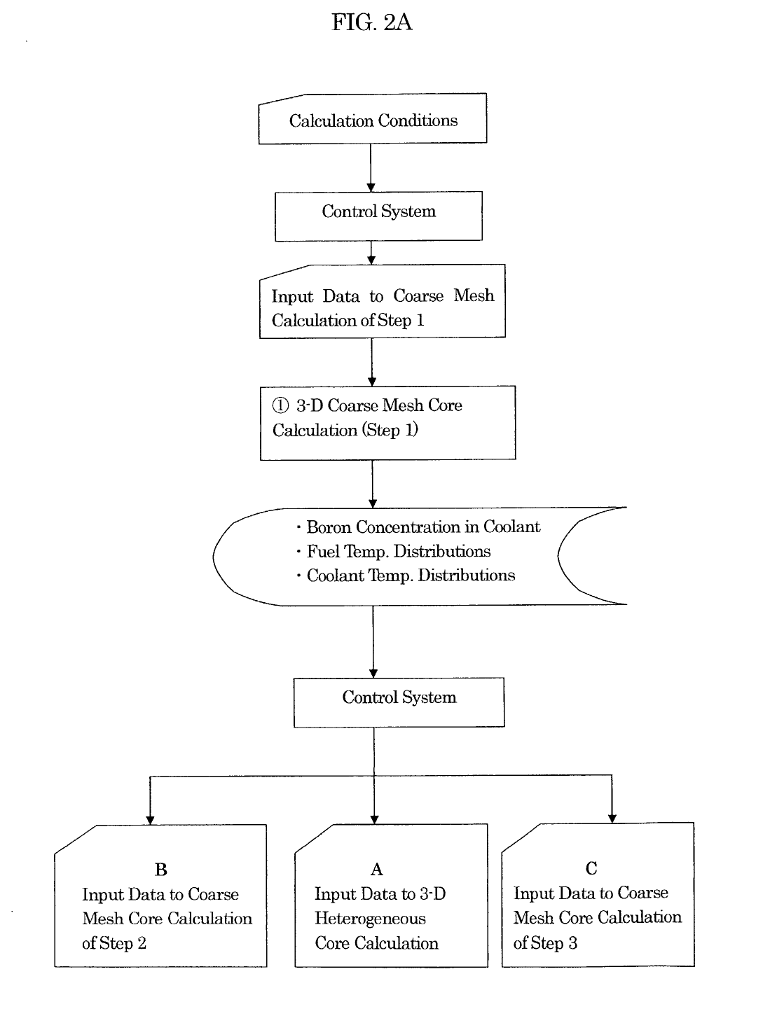

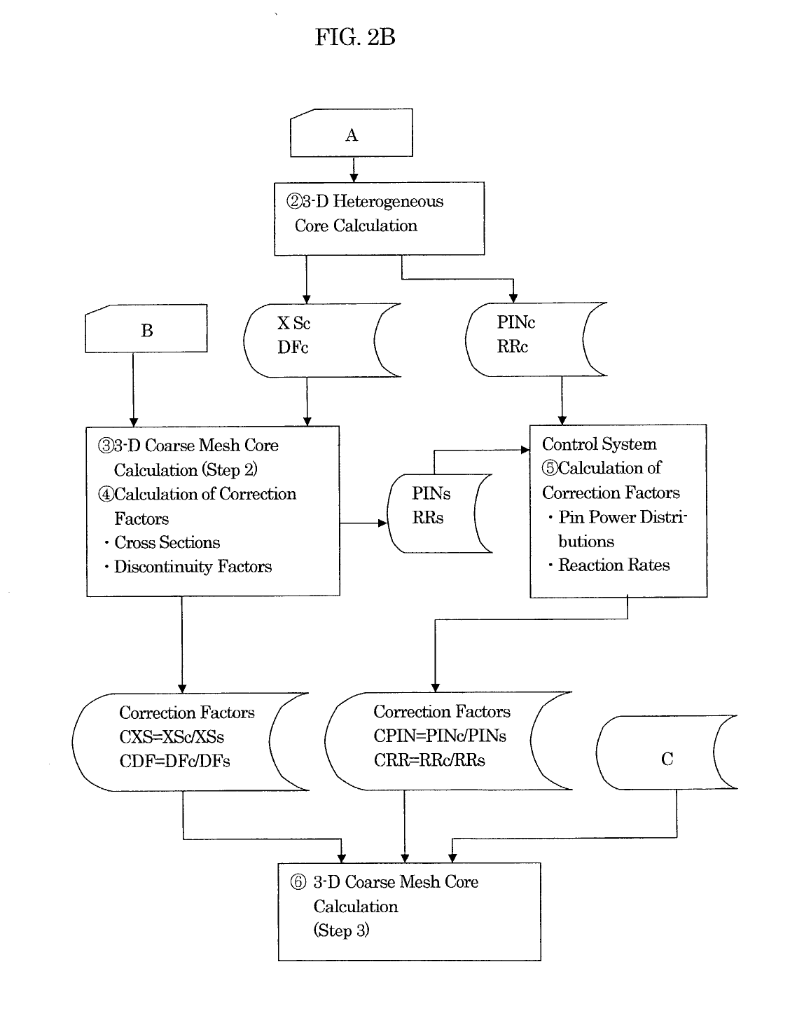

A flow chart of such an example is shown in FIGS. 2A and 2B.

With this example, if only the 3-dimensional heterogeneous core calculation for deriving correction factors is performed once, it is also possible to achieve an equivalent calculation precision to the calculation precision obtainable from a 3-dimensional heterogeneous core calculation method on the system in which the correction factors were derived, according to the procedure shown in FIGS. 2A and 2B. Therefore this is effective in performing a kinetic calculation requiring many calculation steps.

Furthermore since the 3-dimensional heterogeneous core calculation is performed by the use of in-core temperature distributions, etc. calculated in the 3-dimensional coarse mesh core calculation (Step 1), it is possible to avoid alternately repeating neutronics calculation and thermal hydraulic calculation in the 3-dimensional heterogeneous core calculation, thereby curtailing the calculation time.

In this manner, after the three-dimensional coarse mesh core calculation step, it is possible to achieve an equivalent calculation precision to a three-dimensional heterogeneous core calculation method by reason of a combination of a coarse mesh core calculation code and a heterogeneous core calculation code, whereby significant curtailment and reduction of calculation time and memory capacity is achieved.

What is claimed is:

1. A calculation method of a nuclear reactor core on neutronic characteristics and thermal hydraulic characteristics comprising:
performing a first coarse mesh core calculation based on fuel assembly cross section tables including homogeneous fuel assembly cross sections and discontinuity factors at boundaries of fuel assemblies by treating fuel assemblies under homogenization thereof;
performing a heterogeneous core calculation in a system based on the premise of the same core conditions as in the first coarse mesh core calculation;
comparing both calculation results thus obtained with each other thereby deriving correction factors to parameters including at least the homogeneous cross sections and the discontinuity factors;
and performing a second coarse mesh core calculation by use of the correction factors, whereby to get final calculation results equivalent in precision to calculation results obtainable from a heterogeneous core calculation method at high speed.

2. The calculation method of a nuclear reactor core as set forth in claim 1, wherein the same core conditions as in the first coarse mesh core calculation, under which the heterogeneous core calculation is performed, are conditions on boron concentrations in a coolant, fuel temperature distributions and coolant temperature distributions.

3. The calculation method of a nuclear reactor core as set forth in claim 1, wherein said both calculation results and said final calculation results are ones relative to homogeneous fuel assembly cross sections and discontinuity factors at fuel assembly boundaries.

4. A calculation method of a nuclear reactor core on neutronic characteristics and thermal hydraulic characteristics comprising:
performing a two-dimensional coarse mesh core calculation based on fuel assembly cross section tables including homogeneous fuel assembly cross sections and discontinuity factors at boundaries of fuel assemblies by treating fuel assemblies under homogenization thereof;
performing a two-dimensional heterogeneous core calculation in a system based on the premise of the same core conditions as in the two-dimensional coarse mesh core calculation;
comparing both calculation results thus obtained with each other thereby deriving correction factors to parameters including at least the homogeneous cross sections and the discontinuity factors;
and performing further a three-dimensional coarse mesh core calculation in a similar or analogous system to the system in the two-dimensional heterogeneous core calculation by use of the correction factors, whereby to get final calculation results equivalent in precision to calculation results obtainable from a three-dimensional heterogeneous core calculation method at high speed.

5. The calculation method of a nuclear reactor core as set forth in claim 4, wherein the core conditions same as in the first coarse mesh core calculation, under which the heterogeneous core calculation is performed, are conditions on boron concentrations in a coolant, fuel temperature distributions and coolant temperature distributions.

6. The calculation method of a nuclear reactor core as set forth in claim 4, wherein said both calculation results and final calculation results are ones on homogeneous fuel assembly cross sections and discontinuity factors at fuel assembly boundaries.

7. A calculation method of a nuclear reactor core on neutronic characteristics and thermal hydraulic characteristics comprising:
performing a two-dimensional coarse mesh core calculation based on fuel assembly cross section tables including homogeneous fuel assembly cross sections and discontinuity factors at boundaries of fuel assemblies by treating fuel assemblies under homogenization thereof;
performing a two-dimensional heterogeneous core calculation in a system based on the premise of the same core conditions as in the two-dimensional coarse mesh core calculation;
comparing both calculation results thus obtained with each other thereby deriving correction factors to parameters including the homogeneous cross sections, the discontinuity factors, power distributions in fuel assemblies and reaction rates of in-core neutron detectors;
and performing further a three-dimensional coarse mesh core calculation in a similar or analogous system to the system in the two-dimensional heterogeneous core calculation by use of the correction factors, whereby to get final calculation results equivalent in precision to calculation results obtainable from a three-dimensional heterogeneous core calculation method at high speed.

8. The calculation method of a nuclear reactor core as set forth in claim 7, wherein the same core conditions as in the first coarse mesh core calculation, under which the heterogeneous core calculation is performed, are conditions on boron concentrations in a coolant, fuel temperature distributions and coolant temperature distributions.

9. The calculation method of a nuclear reactor core as set forth in claim 7, wherein said both calculation results are ones on homogeneous fuel assembly cross sections, discontinuity factors at fuel assembly boundaries, power distributions in fuel assemblies and reaction rates of in-core neutron detectors.

10. A calculation method of a nuclear reactor core on neutronic characteristics and thermal hydraulic characteristics comprising:
performing a three-dimensional coarse mesh core calculation based on fuel assembly cross section tables including homogeneous fuel assembly cross sections and discontinuity factors at boundaries of fuel assemblies by treating fuel assemblies under homogenization;
performing a three-dimensional heterogeneous core calculation in a system based on the premise of the same core conditions as in the three-dimensional coarse mesh core calculation;
comparing both calculation results thus obtained with each other thereby deriving correction factors to parameters including at least the homogeneous fuel assembly cross sections and the discontinuity factors;
and performing a second three-dimensional coarse mesh core calculation in a similar or analogous system to the system in the three-dimensional heterogeneous core calculation by use of the correction factors, whereby to get final calculation results equal in precision to calculation results obtainable from a three-dimensional heterogeneous core calculation method at high speed.

11. The calculation method of a nuclear reactor core as set forth in claim 10, wherein the core conditions same as in the first coarse mesh core calculation, under which the heterogeneous core calculation is performed, are conditions on boron concentrations in a coolant, fuel temperature distributions and coolant temperature distributions.

12. The calculation method of a nuclear reactor core as set forth in claim 10, wherein said both calculation results and said final calculation results are ones on homogeneous fuel assembly cross sections and discontinuity factors at fuel assembly boundaries.

13. A calculation method of a nuclear reactor core on neutronic characteristics and thermal hydraulic characteristics comprising:
performing a first three-dimensional coarse mesh core calculation based on fuel assembly cross section tables including homogeneous fuel assembly cross sections and discontinuity factors at boundaries of fuel assemblies by treating fuel assemblies under homogenization thereof;
performing a three-dimensional heterogeneous core calculation in a system based on the premise of the same core conditions as in the first three-dimensional coarse mesh core calculation;
comparing both calculation results thus obtained with each other thereby deriving correction factors to parameters including homogeneous fuel assembly cross sections, discontinuity factors at fuel assemblies boundaries, power distributions in fuel assemblies and reaction rates of in-core neutron detectors;
and performing further a second three-dimensional coarse mesh core calculation in a similar or analogous system to the system in the three-dimensional heterogeneous core calculation by use of the correction factors, whereby to get final calculation results equivalent in precision to calculation results obtainable from a three-dimensional heterogeneous core calculation method at high speed.

14. The calculation method of a nuclear reactor core as set forth in claim 13, wherein the core conditions same as in the first coarse mesh core calculation, under which the heterogeneous core calculation is performed, are conditions on boron concentrations in a coolant, fuel temperature distributions and coolant temperature distributions.

15. The calculation method of a nuclear reactor core as set forth in claim 13, wherein said both calculation results and said final calculation results are ones on homogeneous fuel assembly cross sections, discontinuity factors at fuel assembly boundaries, power distributions in fuel assemblies and reaction rates of in-core neutron detectors.
